(19) United States
(12) Patent Application Publication
(10) Pub. No.: US 2007/0059113 A1
(43) Pub. Date: Mar. 15, 2007

(54) Hole saw having depth of travel indicia

(76) Inventor: Richard E. Capstran, Milwaukee, WI (US)

Correspondence Address: DONALD J. ERSLER, S.C., 725 GARVENS AVENUE, BROOKFIELD, WI, 53005, US

(21) Appl. No.: 11/226,680

(22) Filed: Sep. 14, 2005

(51) Int. Cl. B23B 51/04

(52) U.S. Cl. 408/204

(57) ABSTRACT

A hole saw having depth of travel indicia includes a hole saw with indica marks formed on an outer diameter thereof. The indica marks are preferably formed in the outer diameter of the hole saw with any suitable process. The indica mark preferably is formed perpendicular to the center axis of the hole saw. The indicia mark could continue around the entire outer diameter or have a set length. The location of each indicia mark is a set dimension from tips of the cutting teeth of the hole saw. A dimension is preferably stamped adjacent each indicia mark to indicate the distance from each indicia mark to the tips of the cutting teeth.

### BACKGROUND OF THE INVENTION

1. Field of the Invention

The present invention relates generally to hole saws and more specifically to a hole saw having depth of travel indicia for showing the length traveled by the hole saw through a work piece.

2. Discussion of the Prior Art

It appears that the prior art does not disclose a hole saw with indicia marked on an outside diameter to indicate how far the hole saw has been inserted into a work piece. The appearance of a perimeter of a hole formed through a back side of a work piece is dependent upon how fast the hole saw breaks through the back side. If the operator, plunges the hole saw through the work piece quickly, the back side of the hole will have large pieces of material broken-out along the perimeter of the hole. If the operator plunges the hole saw through the work piece slowly, the back side of the hole will have small pieces of material broken-out along the perimeter of the hole.

Accordingly, there is a clearly felt need in the art for a hole saw having depth of travel indicia, which shows how far the hole saw has been inserted into a work piece.

### SUMMARY OF THE INVENTION

The present invention provides a hole saw having depth of travel indicia for showing the length traveled by the hole saw. The hole saw having depth of travel indicia (hole saw with indicia) includes a hole saw with indica marks formed on an outer diameter thereof. The indica marks are preferably formed in the outer diameter of the hole saw with engraving or any other suitable process. Each indicia mark is preferably a line. The indica mark preferably is formed perpendicular to the center axis of the hole saw. The indicia mark could continue around the entire outer diameter or have a set length. The location of each indicia mark is a set dimension from tips of the cutting teeth of the hole saw. Preferably, a dimension is stamped adjacent each indicia mark to indicate the distance from each indicia mark to the tips of the cutting teeth.

Accordingly, it is an object of the present invention to provide a hole saw with indicia that indicate how far a hole saw has been inserted into a work piece.

These and additional objects, advantages, features and benefits of the present invention will become apparent from the following specification.

### BRIEF DESCRIPTION OF THE DRAWINGS

FIG. 1 is a perspective view of a hole saw with indicia in accordance with the present invention.

FIG. 2 is a side view of a hole saw with indicia in accordance with the present invention.

FIG. 3 is a partial cross sectional view of a wall of a hole saw with indicia in accordance with the present invention.

### DETAILED DESCRIPTION OF THE PREFERRED EMBODIMENTS

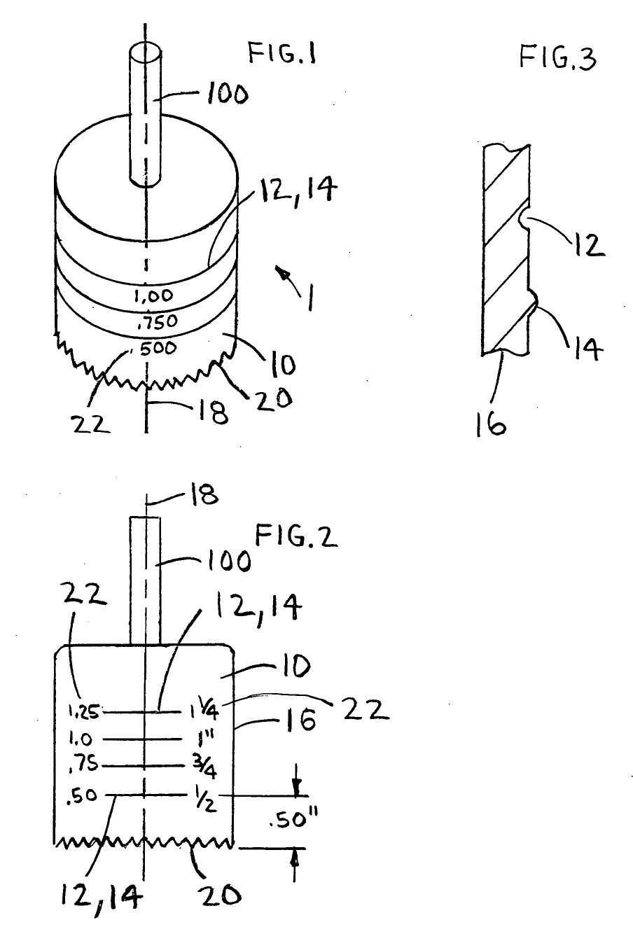

With reference now to the drawings, and particularly to FIG. 1, there is shown a perspective view of a hole saw with indica 1. With reference to FIG. 2, the hole saw with indicia 1 includes a hole saw 10 with at least one indica mark 12 formed on an outer diameter of the hole saw 10. Hole saws are well known in the art and need not be explained in detail. A shank 100 is attached to a top of the hole saw 10 with any suitable method to allow thereof to be rotated. With reference to FIG. 3, the indica marks 12 are preferably formed below an outer diameter surface of a side wall 16 of the hole saw 10 by removing material from the side wall 16, compressing material into the side wall 16 or through any other method to form a depression. However, a protruding indicia mark 14 may also be formed in the side wall 16 of the hole saw 10 with any suitable process. The cross sectional shape of the indicia mark 12 or the protruding indica mark 14 should not be limited to that shown in the figures, but could have any suitable shape. Each indicia mark 12, 14 is preferably a line.

The indica mark 12, 14 is preferably formed perpendicular to the center axis 18 of the hole saw 10. The indica mark 12, 14 could continue around the entire outer diameter 16 as shown in FIG. 1 or have a set length as shown in FIG. 2. The location of each indicia mark 12, 14 is a set dimension from tips of the cutting teeth 20 formed on an end of the hole saw 10. A dimension 22 is preferably stamped adjacent each indicia mark 12, 14 to indicate the distance from each indicia mark 12 to the tips of the cutting teeth 20. The dimension 22 could be fractional, decimal or both. The dimension 22 could also be in english or metric.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A hole saw having depth of travel indicia, comprising:
a hole saw having a plurality of cutting teeth formed on an end thereof, said hole saw having a center axis; and
forming at least one indica mark on an outer diameter of said hole saw, each one of said at least one indicia mark being located a set dimension from tips of said cutting teeth.

2. The hole saw having depth of travel indicia of claim 1, wherein:
a dimension of the distance from said tips of said cutting teeth to one of said at least one indica mark being marked on said outer diameter.

3. The hole saw having depth of travel indicia of claim 2, wherein:
said dimension being at least one of a decimal number and a fractional number.

4. The hole saw having depth of travel indicia of claim 1, wherein:
said at least one indicia mark being formed below an outer diameter surface of a side wall of said hole saw.

5. The hole saw having depth of travel indicia of claim 1, wherein:
said at least one indicia mark protruding from a side wall of said hole saw.

6. The hole saw having depth of travel indicia of claim 1, wherein:
said at least one indicia mark being formed perpendicular to a center axis of said hole saw.

7. The hole saw having depth of travel indicia of claim 1, wherein:
said at least one indicia mark being formed around an outer diameter of said hole saw.

8. The hole saw having depth of travel indicia of claim 1, wherein:
each one of said at least one indicia mark being a line.

9. A hole saw having depth of travel indicia, comprising:
a hole saw having a plurality of cutting teeth formed on an end thereof, said hole saw having a center axis;
forming at least one indica mark on an outer diameter of said hole saw, each one of said at least one indicia mark being located a set dimension from tips of said cutting teeth;
a dimension of the distance from said tips of said cutting teeth to one of said at least one indica mark being marked on said outer diameter.

10. The hole saw having depth of travel indicia of claim 9, wherein:
said dimension being at least one of a decimal number and a fractional number.

11. The hole saw having depth of travel indicia of claim 9, wherein:
said at least one indicia mark being formed below an outer diameter surface of a side wall of said hole saw.

12. The hole saw having depth of travel indicia of claim 9, wherein:
said at least one indicia mark protruding from a side wall of said hole saw.

13. The hole saw having depth of travel indicia of claim 9, wherein:
said at least one indicia mark being formed perpendicular to a center axis of said hole saw.

14. The hole saw having depth of travel indicia of claim 9, wherein:
said at least one indicia mark being formed around an outer diameter of said hole saw.

15. The hole saw having depth of travel indicia of claim 9, wherein:
each one of said at least one indicia mark being a line.

16. A hole saw having depth of travel indicia, comprising:
a hole saw having a plurality of cutting teeth formed on an end thereof, said hole saw having a center axis;
forming at least one indica mark below an outer diameter surface of a side wall of said hole saw, each one of said at least one indicia mark being located a set dimension from tips of said cutting teeth;
a dimension of the distance from said tips of said cutting teeth to one of said at least one indica mark being marked on said outer diameter.

17. The hole saw having depth of travel indicia of claim 16, wherein:
said dimension being at least one of a decimal number and a fractional number.

18. The hole saw having depth of travel indicia of claim 16, wherein:
said at least one indicia mark being formed perpendicular to a center axis of said hole saw.

19. The hole saw having depth of travel indicia of claim 16, wherein:
said at least one indicia mark being formed around an outer diameter of said hole saw.

20. The hole saw having depth of travel indicia of claim 16, wherein:
each one of said at least one indicia mark being a line.
